(19) United States
(12) Patent Application Publication
(10) Pub. No.: US 2025/0231920 A1
(43) Pub. Date: Jul. 17, 2025

(54) SYSTEM AND METHOD FOR MANAGING CLOUD-BASED DATA PLATFORMS WITH LIMITED CAPACITY STORAGE SETS

(71) Applicant: Microsoft Technology Licensing, LLC, Redmond, WA (US)

(72) Inventors: Jeremy P. Buls, Bellevue, WA (US); Jeffrey Bonner, Seattle, WA (US); Ram Kumar Donthula, Bothell, WA (US); Adam Curtis Venezia, Vineyard, UT (US); Anand Rengasamy, Bothell, WA (US); Youssef Boukenken, Columbia, SC (US); Rohan Vivek Patil, Sammamish, WA (US)

(21) Appl. No.: 18/415,007

(22) Filed: Jan. 17, 2024

(51) Int. Cl. G06F 16/185; G06F 16/22

(52) U.S. Cl. CPC G06F 16/185; G06F 16/2282

(57) ABSTRACT

A method, computer program product, and computing system for processing a partition size exception associated with a write request for writing a portion of data to a distributed database storage container associated with a partition key within a distributed database system. A partition table entry for the partition key is processed from a partition table. A new linked partition key is generated based upon, at least in part, a previous linked partition key from the partition table entry for the partition key. A distributed database storage container associated with the new linked partition key is generated. The portion of data is written to the distributed database storage container associated with the new linked partition key.

### BACKGROUND

Cloud storage system users need to view and manage their service-specific data quickly and consistently. To provide this experience, data is usually organized into different “storage sets” where each storage set has a unique identifier representing a logical set (e.g., a single user, a common type of storage device, etc.). These storage sets are used throughout cloud applications in data storage solutions to meet the performance expectations of applications and their end-users.

While horizontally scaled storage platforms allow for an unlimited number of storage sets, the maximum capacity of an individual storage set is limited and cannot be expanded. When one user's data exceeds the storage set's maximum allowed capacity, current techniques are unable to store and maintain their data in a way which can meet the same performance expectations without data loss.

### BRIEF DESCRIPTION OF THE DRAWINGS

FIG. 1 is a flow chart of one implementation of a partitioned cloud storage management process;

FIG. 2 is a diagrammatic view of a distributed database system with various regional database instances;

FIGS. 3-6 are diagrammatic views of the partitioned cloud storage management process of FIG. 1;

FIGS. 7-8 are diagrammatic view of a distributed database system with cached partition tables across the various regional database instances; and

FIG. 9 is a diagrammatic view of computer system and the partitioned cloud storage management process coupled to a distributed computing network.

Like reference symbols in the various drawings indicate like elements.

### DETAILED DESCRIPTION OF THE EMBODIMENTS

Implementations of the present disclosure enable low-level read/write operations on a single logical data set of any size, stored across multiple storage sets of the underlying platform. All higher-level operations and data consumers are abstracted and are able to serve a large influx of data while still maintaining performance expectations.

Other solutions require restructuring data in the underlying storage platform and modifying higher-level operations to work with the restructured data. Such restructuring leads to high costs in terms of time and resources, and it can still be impossible to maintain existing methods of data retrieval with the same performance for applications and their end-users.

As will be described in greater detail below, implementations of the present disclosure process a partition size exception associated with a write request for writing a portion of data to a distributed database storage container associated with a partition key within a distributed database system. For example, when writing data to a distributed database system, data access and storage is organized into discrete distributed database storage containers. These distributed database storage containers have limited storage capacity. Access to a specific distributed database storage container is defined by a partition key that is provided with a read and/or write request. However, when a distributed database storage container reaches its capacity, a partition size exception is sent to the requesting user. The primary challenges associated with a partition size exception are: 1) the data of a write request is not written to the distributed database storage container; and 2) in order to continue to access the data in the distributed database storage container using the same partition key, the data must be re-written to a larger distributed database storage container.

As such, the partitioned cloud storage management process of the present disclosure generates and manages a partition table and links related partition keys together. For example, when a partition size exception associated with a write request is processed, the partitioned cloud storage management process of the present disclosure accesses a partition table entry for the partition key from a partition table. A new linked partition key is generated based upon, at least in part, a previous linked partition key from the partition table entry for the partition key. For example, suppose that a write request includes a partition key (e.g., partition key “a”). Normally, a partition size exception would result in the data not being written to the distributed database storage container associated with partition key “a” and would require restructuring the data from that distributed database storage container into a larger distributed database storage container. By contrast, the partitioned cloud storage management process of the present disclosure generates a new linked partition key (i.e., partition key “a_1”) that the partition table links with partition key “a”. A new distributed database storage container associated with the new linked partition key is generated and the portion of data is written to the distributed database storage container associated with the new linked partition key.

During subsequent access to the data (i.e., a read request with partition key “a”), the partitioned cloud storage management process accesses the partition table to look up the partition key (e.g., partition key “a”) and any linked partition keys (e.g., partition key “a_1”) and the respective distributed database storage containers associated with each partition key/linked partition key. The requested data is then queried from each distributed database storage container and returned to the requesting user. This approach does not require the user to manage any linked partition keys to either write to or read from a distributed database storage container.

Using implementations of the present disclosure, data sets of any size can be stored with minimal additional cost, and the pitfalls associated with restructuring the underlying storage platform can be avoided. No additional integration work is required for user that are abstracted from direct interactions with the storage platform. Accordingly, this approach ensures that data is not lost due to storage constraints, and that existing services can continue functioning as normal to access the stored data.

The details of one or more implementations are set forth in the accompanying drawings and the description below. Other features and advantages will become apparent from the description, the drawings, and the claims.

### The Partitioned Cloud Storage Management Process:

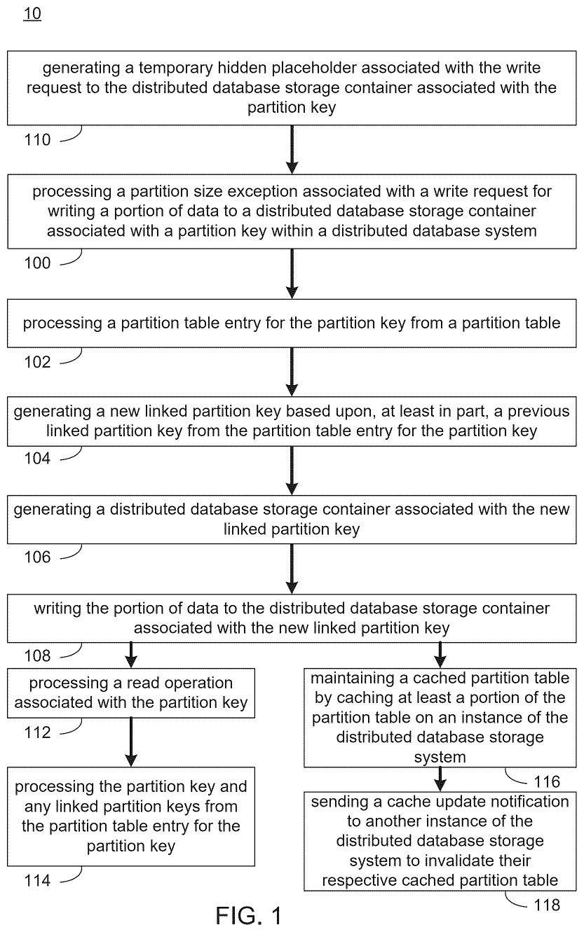

Referring to FIGS. 1-8, partitioned cloud storage management process 10 processes 100 a partition size exception associated with a write request for writing a portion of data to a distributed database storage container associated with a partition key within a distributed database system. A partition table entry for the partition key is processed 102 from a partition table. A new linked partition key is generated 104 based upon, at least in part, a previous linked partition key from the partition table entry for the partition key. A distributed database storage container associated with the new linked partition key is generated 106. The portion of data is written 108 to the distributed database storage container associated with the new linked partition key.

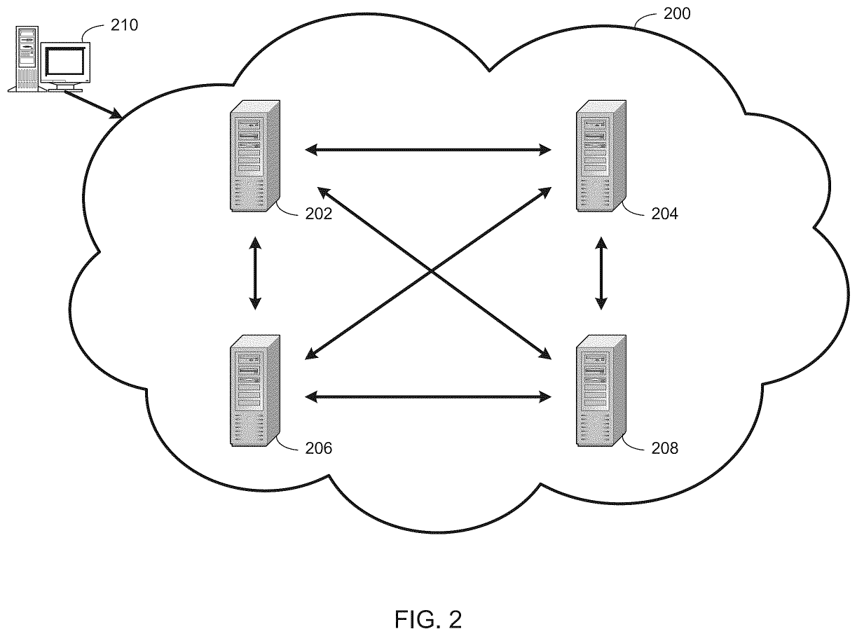

In some implementations, partitioned cloud storage management process 10 processes 100 a partition size exception associated with a write request for writing a portion of data to a distributed database storage container associated with a partition key within a distributed database system. Referring also to FIG. 2, a distributed database system (e.g., distributed database system 200) is a system of interconnected but physically separated database instances or nodes (e.g., database instances 202, 204, 206, 208) that spread the processing load by storing and processing data across multiple nodes. Each database instance (e.g., database instances 202, 204, 206, 208) stores a portion of the data and collaborates with other database instances or nodes to provide access to users (e.g., user represented using computing device 210) to the data stored thereon. In some implementations, distributed database system 200 includes communication protocols to provide coordinated data sharing, fault tolerance, and scalability. In this manner, distributed database system 200 allows users to build and distribute applications across the whole distributed database system automatically without any need for prior configuration.

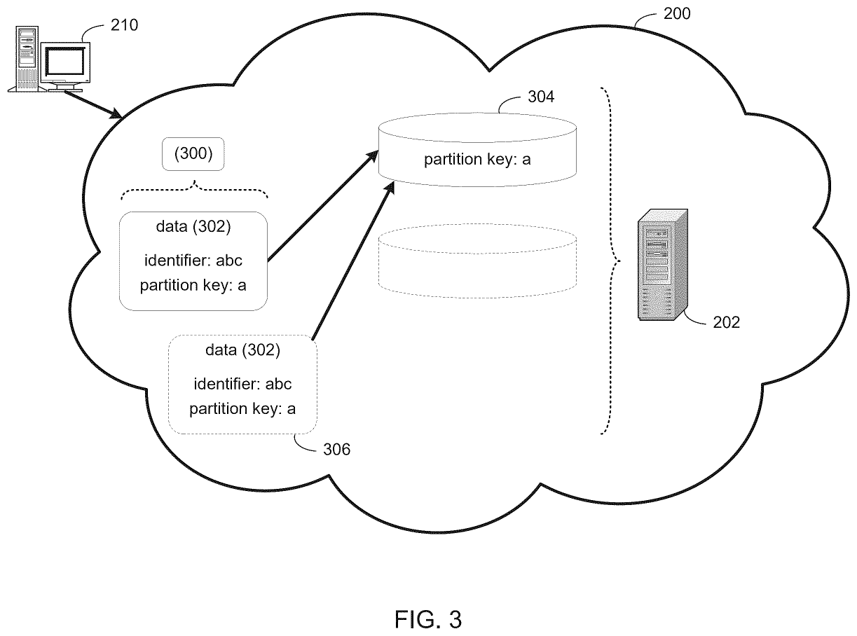

Referring also to FIG. 3, a database instance (e.g., database instance 202) of distributed database system 200 is shown. In one example, suppose partitioned cloud storage management process 10 processes a write request (e.g., write request 300) for writing a portion of data (e.g., data 302) to a distributed database storage container (e.g., distributed database storage container 304). A distributed database storage container (e.g., distributed database storage container 304) generally include an individually addressable portion of storage capacity within database instance 202.

In some implementations, each distributed database storage container has a fixed storage capacity. In one example, distributed database storage container 304 has a fixed storage capacity that is predefined when distributed database storage container 304 is allocated within database instance 202. For example, suppose database instance 202 is accessed by multiple users. In this example, partitioned cloud storage management process 10 allocates distributed database storage container 304 to one user, another distributed database storage container to another user, and another distributed database storage container to another user. In this manner, partitioned cloud storage management process 10 separates user data across unique distributed database storage containers. In another example, partitioned cloud storage management process 10 allocates distributed database storage containers for different periods of time (i.e., data associated with access during particular periods of time). In another example, partitioned cloud storage management process 10 allocates distributed database storage containers for different applications (i.e., data associated with the execution of a particular application is allocated to a distributed database storage container). In one example, the fixed storage capacity is twenty gigabytes (e.g., 20 GB). However, it will be appreciated that any fixed storage capacity may be used within the scope of the present disclosure. It will also be appreciated that various sized storage capacities may be used across different distributed database storage containers. In this manner, it will be appreciated that each distributed database storage container may include different fixed storage capacities.

Referring again to FIG. 3 and in some implementations, suppose write request 300 includes a request to write data 302. In this example, data 302 includes an identifier (e.g., “abc”) and a partition key (e.g., “a”). In some implementations, an identifier is a unique reference to the data itself (e.g., a file name or reference string). In one example, the identifier is provided with write request 300. In another example, the identifier is defined by distributed database system 200. A partition key is a unique reference to a distributed database storage container. As discussed above in one example, partition key may be defined for a unique user. However, partition keys may be defined for various types of distributed database storage containers within the scope of the present disclosure.

In some implementations when processing write request 300, partitioned cloud storage management process 10 determines an identifier and a partition key from the data of the write request. In this example, partitioned cloud storage management process 10 determines an identifier of “abc” and a partition key of “a” for data 302 from write request 300. Using partition key “a”, partitioned cloud storage management process 10 identifies a distributed database storage container associated with partition key “a”. In this example, partitioned cloud storage management process 10 identifies distributed database storage container 304 associated with partition key “a”.

In some implementations, partitioned cloud storage management process 10 generates 110 a temporary hidden placeholder associated with the write request to the distributed database storage container associated with the partition key. Referring again to FIG. 3, when processing 100 write request 300, partitioned cloud storage management process 10 generates 110 a temporary hidden placeholder (e.g., temporary hidden placeholder 306) associated with write request 300. In some implementations, temporary hidden placeholder 306 is a reference to data 302 being written to a database instance that provides for concurrency with other database instances. For example and as will be described in greater detail below, suppose that when writing data 302 to distributed database storage container 304, distributed database storage container 304 does not have sufficient free storage capacity to store data 302. In this example, partitioned cloud storage management process 10 writes temporary hidden placeholder 306 as a soft-deleted entry (i.e., a flag that marks data as unusable, without erasing the data itself from the distributed database storage container) for data 302. Temporary hidden placeholder 306 is temporary because it exists for a predefined period of time (e.g., thirty minutes or another amount of time); is hidden because it cannot be accessed for reading but is identifiable by other database instances for concurrency checking; and is a placeholder because it prevents other data from being written to the same location to ensure concurrency across database instances. In this manner, other database instances are unable to access or overwrite data 302 until the data 302 is written to another distributed database storage container.

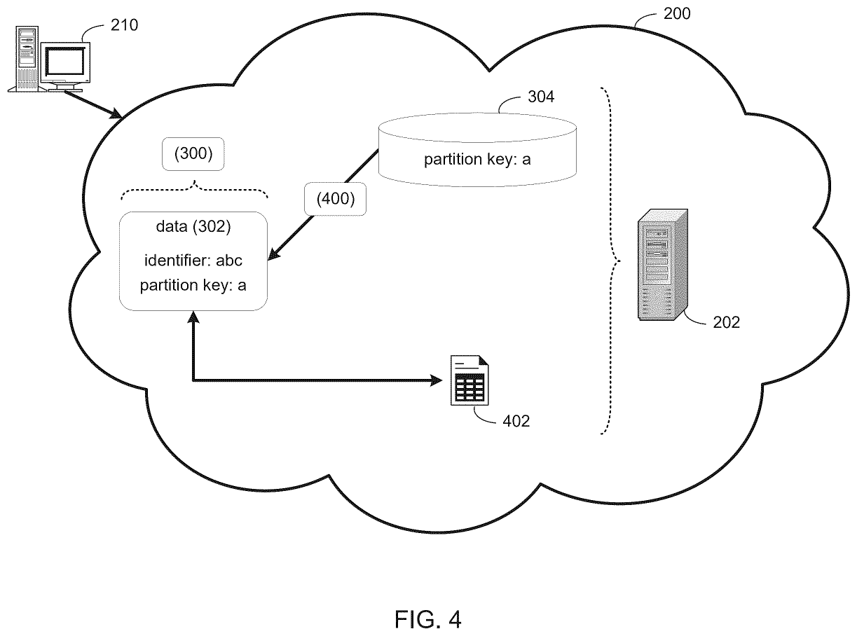

Referring also to FIG. 4, partitioned cloud storage management process 10 processes 100 write request 300 on distributed database storage container 304 by comparing the size of data 302 to be written to distributed database storage container 304 and the available storage capacity of distributed database storage container 304. If distributed database storage container 304 has sufficient storage capacity, database instance 202 writes data 302 to distributed database storage container 304. If distributed database storage container 304 does not have sufficient storage capacity, database instance 202 issues a partition size exception (e.g., partition size exception 400) indicating that distributed database storage container 304 is unable to store data 302. A partition size exception (e.g., partition size exception 400) is an indication that distributed database storage container 304 has insufficient free storage capacity to store data 302. Conventional approaches would generally indicate that data 302 cannot be stored due to insufficient free storage capacity for distributed database storage container 304 and that distributed database storage container 304 would need to be restructured (i.e., copied to a larger distributed database storage container) in order to keep the data organized by the same partition key. Otherwise, data 302 would be stored in a different distributed database storage container with a different partition key. In this manner, read requests would not be limited to a particular partition key and user devices seeking to access the data would need to maintain multiple partition keys to query. However and as will be discussed in greater detail below, by using a partition table to link related linked partition keys, multiple distributed database storage containers can be used to store data using the same partition key.

In some implementations, partitioned cloud storage management process 10 processes 102 a partition table entry for the partition key from a partition table. A partition table (e.g., partition table 402) is a listing of partition keys and linked partition keys associated with each partition key. In some implementations and as will be described in greater detail below, partition table 402 is a database of entries for partition keys and any linked partition keys. Suppose partitioned cloud storage management process 10 processes 100 partition size exception 400 for writing data 302 to distributed database storage container 304. In this example, partitioned cloud storage management process 10 processes partition table 402 to determine whether another distributed database storage container is available that is accessible using the same partition key (e.g., partition key “a”). For example, in response to processing 100 partition size exception 400, partitioned cloud storage management process 10 processes 102 partition table 402 to identify any partition table entries associated with partition key “a” for data 302.

In some implementations, partitioned cloud storage management process 10 generates 104 a new linked partition key based upon, at least in part, a previous linked partition key from the partition table entry for the partition key. A linked partition key is a reference to a new partition key that is related to or associated with a previous partition key. For example, when processing 102 partition table 402, partitioned cloud storage management process 10 determines whether a previous linked partition key entry exists for partition key “a”. In this example, suppose no previous linked partition key entry exists for partition key “a” in partition table 402. Accordingly, partitioned cloud storage management process 10 generates a new linked partition key (e.g., partition key “a_1”) based upon, at least in part, a previous partition key (e.g., partition key “a”). In one example, partitioned cloud storage management process 10 generates 104 new linked partition key “a_1” by incrementing a previous partition key subscript by one. For example, partitioned cloud storage management process 10 generates 104 new linked partition key “a_1” for previous linked partition key “a” and generates 104 new linked partition key “a_2” for previous partition key “a_1” and so on. While the above example concerns a specific incrementation of an underscore character and an incremented number, it will be appreciated that various incrementations of a previous partition key can be used to generate 104 new linked partition keys within the scope of the present disclosure. As will be discussed in greater detail below, partitioned cloud storage management process 10 uses partition table 402 to access data.

In some implementations, partitioned cloud storage management process 10 generates 106 a distributed database storage container associated with the new linked partition key. For example, in response to generating 104 a new linked partition key (e.g., partition key “a_1”), partitioned cloud storage management process 10 generates an additional distributed database storage container (e.g., distributed database storage container 500) that is associated with the new linked partition key (e.g., partition key “a 1”). In one example, generating 106 distributed database storage container 500 includes allocating a new distributed database storage container for the new linked partition key. In another example, generating 106 distributed database storage container 500 includes reallocating an existing distributed database storage container for the new linked partition key.

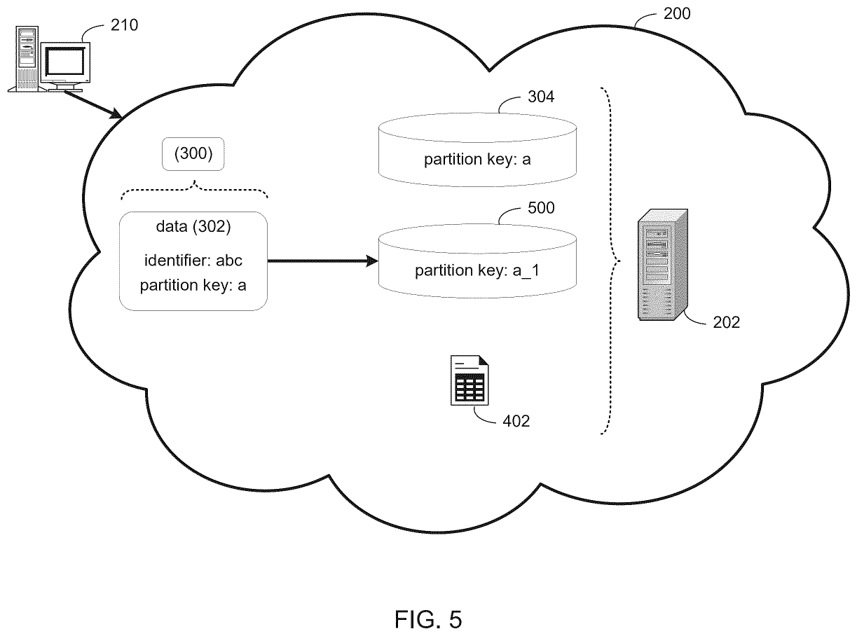

In some implementations, partitioned cloud storage management process 10 writes 108 the portion of data to the distributed database storage container associated with the new linked partition key. Referring again to FIG. 5 and in response to generating 106 distributed database storage container 500, partitioned cloud storage management process 10 writes 108 data 302 to distributed database storage container 500 associated with the new linked partition key (e.g., partition key “a_1”). In this manner, partitioned cloud storage management process 10 allows write requests for data associated with particular partition keys to be processed when a distributed database storage container is full (i.e., by generating new linked partition keys using the previous partition key). Accordingly, and as will be discussed in greater detail below, a user is able to reference the same partition key for both writing and reading data without restructuring the stored data.

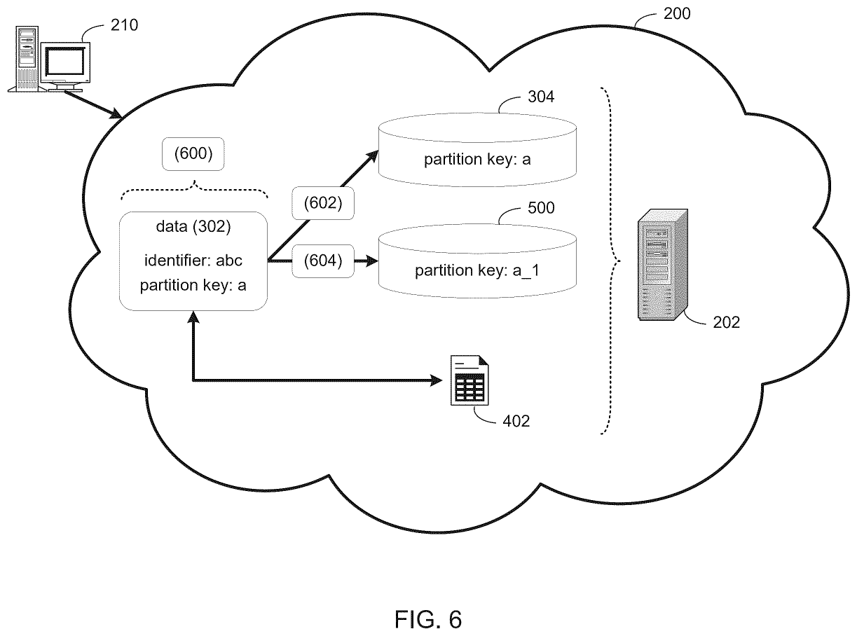

In some implementations, partitioned cloud storage management process 10 processes 112 a read operation associated with the partition key. Referring also to FIG. 6, suppose distributed database system 200 receives a read request (e.g., read request 600) from a user (e.g., user 210). In this example, suppose read request 600 includes a request to access data 302 with identifier “abc” and partition key “a”. Conventional approaches to reading data from a distributed database system include using the partition key to identify the distributed database storage container associated with the partition key. However, conventional approaches respond to partition size exceptions by restructuring an existing distributed database storage container into a larger distributed database storage container. As such, the partition key is preserved but expensive operations (e.g., in terms of time and memory resources) are required to preserve access to the same data with the same partition key. By contrast, implementations of the present disclosure allow read operations to use a single partition key to read data from multiple linked partition keys using the partition table. In this manner, partitioned cloud storage management process 10 provides seamless read access to data stored using a particular partition key even if the data is ultimately stored in a distributed database storage container that is associated with a linked partition key.

In some implementations, processing 112 the read operation includes processing 114 the partition key and any linked partition keys from the partition table entry for the partition key. For example, partitioned cloud storage management process 10 accesses partition table 402 to identify the distributed database storage container associated with the partition key of read request 600 (e.g., partition key “a”) and any linked partition keys. In this example, partitioned cloud storage management process 10 processes 114 partition key “a” and linked partition key “a_1” from partition table 402 from read request 600. Using partition key “a” and linked partition key “a_1”, partitioned cloud storage management process 10, is able to process read request 600 by generating a separate query for data 302 for each distributed database storage container (e.g., query 602 to distributed database storage container 304 and query 604 to distributed database storage container 500). In some implementations, each query includes the identifier for data 302 (e.g., identifier “abc”). In this example, partitioned cloud storage management process 10 reads data 302 from distributed database storage container 500 associated with partition key “a_1”.

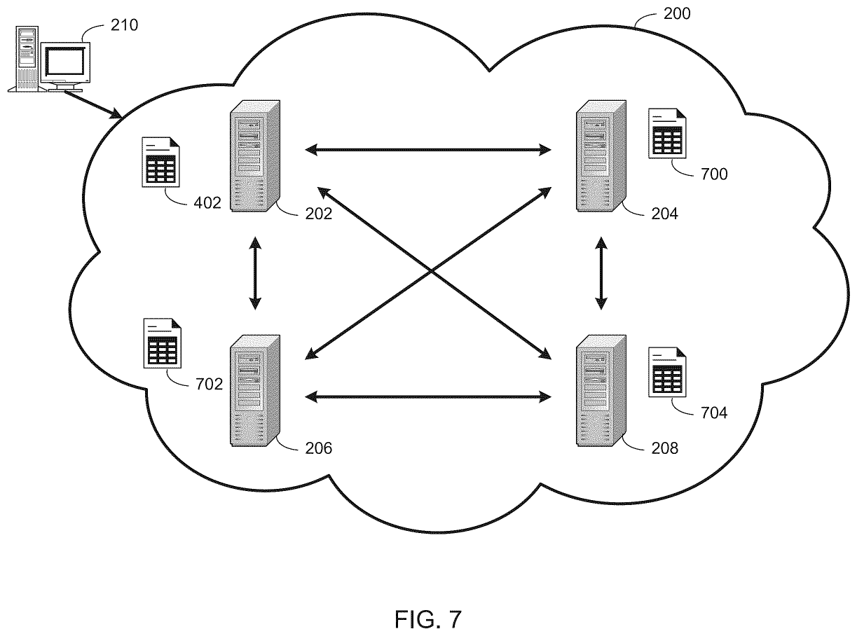

In some implementations, partitioned cloud storage management process 10 maintains 116 a cached partition table by caching at least a portion of the partition table on an instance of the distributed database system. Referring also to FIG. 7, suppose database instance 202 processes a write request from a user. In this example and as discussed above, suppose partitioned cloud storage management process 10 generates a linked partition key to store the data of the write request to a new distributed database storage container. Accordingly, partitioned cloud storage management process 10 generates a new linked partition key entry in its partition table (e.g., partition table 402). In responses to generating the new linked partition key entry in its partition table, partitioned cloud storage management process 10 maintains 116 a cached partition table (e.g., partition table 402) within the respective database instance (e.g., database instance 202).

In some implementations, the distributed database system includes a cached partition table for each regional instance of the distributed database system. For example, suppose database instances 202, 204, 206, and 208 are physically or geographically regional database instances of distributed database system 200. In this example, partitioned cloud storage management process 10 maintains a cached partition table in each regional database instance (e.g., cached partition table 402 in database instance 202; cached partition table 700 in database instance 204; cached partition table 702 in database instance 206; and cached partition table 704 in database instance 208). In this manner, partitioned cloud storage management process 10 limits the computational expenses (in terms of memory and time) required to obtain and process a centralized partition table for distributed database system by maintaining 116 cached partition tables 402, 700, 702, 704 for each respective database instance (e.g., database instances 202, 204, 206, 208).

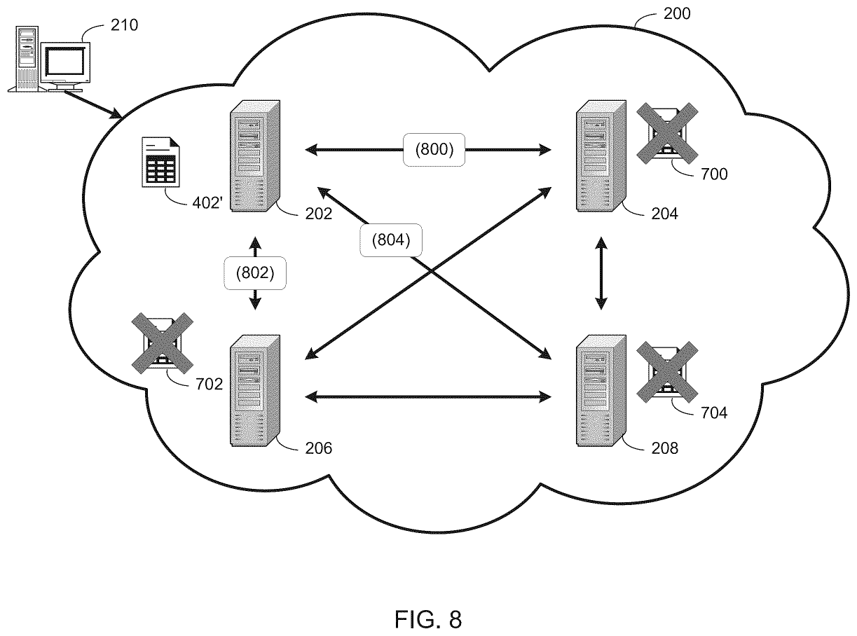

In some implementations and in response to generating a new linked partition key, partitioned cloud storage management process 10 sends 118 a cache update notification to another instance of the distributed database system to invalidate their respective cached partition table. For example and referring also to FIG. 8, suppose that partitioned cloud storage management process 10 generates 104 a new linked partition key when processing a write request. In this example, partitioned cloud storage management process 10 generates an updated partition table for database instance 202 (e.g., updated partition table 402′). As this partition table is no longer synchronized with partition tables 700, 702, 704, partitioned cloud storage management process 10 sends 118 a cache update notification (e.g., cache update notification 800 to database instance 204; cache update notification 802 to database instance 206; and cache update notification 804 to database instance 208). Cache update notifications are messages that inform a database instance that the cached partition table has been updated on another database instance in the distributed database system. In one example, cache update notifications describe the updates to the partition table. In another example, cache update notifications describe a location from which updates to the partition table can be obtained. Accordingly, in response to receiving cache update notifications, each database instance invalidates its respective partition table from subsequent processing of partition keys and either obtains the updates for its partition table or obtains an updated partition table in its entirety. As shown in FIG. 8, invalidated partition tables 700, 702, 704 are crossed out indicating that they are not accessible until each partition table is updated.

### System Overview:

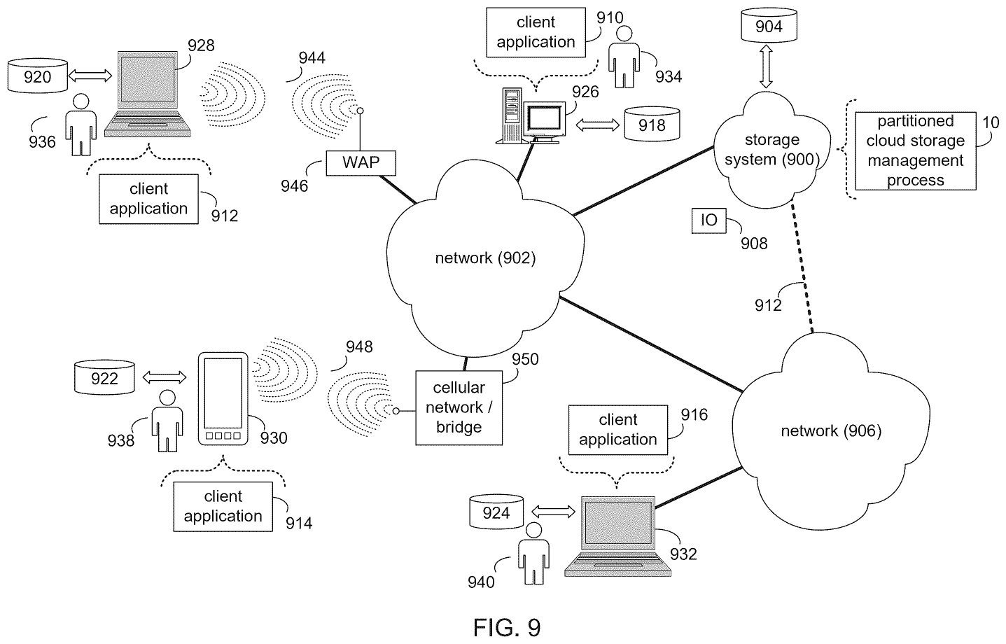

Referring to FIG. 9, a partitioned cloud storage management process 10 is shown to reside on and is executed by storage system 900, which is connected to network 902 (e.g., the Internet or a local area network). Examples of storage system 900 include: a Network Attached Storage (NAS) system, a Storage Area Network (SAN), a personal computer with a memory system, a server computer with a memory system, and a cloud-based device with a memory system. A SAN includes one or more of a personal computer, a server computer, a series of server computers, a minicomputer, a mainframe computer, a RAID device, and a NAS system.

The various components of storage system 900 execute one or more operating systems, examples of which include: Microsoft® Windows®; Mac® OS X®; Red Hat Linux®, Windows® Mobile, Chrome OS, Blackberry OS, Fire OS, or a custom operating system (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of partitioned cloud storage management process 10, which are stored on storage device 904 included within storage system 900, are executed by one or more processors (not shown) and one or more memory architectures (not shown) included within storage system 900. Storage device 904 may include: a hard disk drive; an optical drive; a RAID device; a random-access memory (RAM); a read-only memory (ROM); and all forms of flash memory storage devices. Additionally or alternatively, some portions of the instruction sets and subroutines of partitioned cloud storage management process 10 are stored on storage devices (and/or executed by processors and memory architectures) that are external to storage system 900.

In some implementations, network 902 is connected to one or more secondary networks (e.g., network 906), examples of which include: a local area network; a wide area network; or an intranet.

Various input/output (IO) requests (e.g., IO request 908) are sent from client applications 910, 912, 914, 916 to storage system 900. Examples of IO request 908 include data write requests (e.g., a request that content be written to storage system 900) and data read requests (e.g., a request that content be read from storage system 900).

The instruction sets and subroutines of client applications 910, 912, 914, 916, which may be stored on storage devices 918, 920, 922, 924 (respectively) coupled to client electronic devices 926, 928, 930, 932 (respectively), may be executed by one or more processors (not shown) and one or more memory architectures (not shown) incorporated into client electronic devices 926, 928, 930, 932 (respectively). Storage devices 918, 920, 922, 924 may include: hard disk drives; tape drives; optical drives; RAID devices; random access memories (RAM); read-only memories (ROM), and all forms of flash memory storage devices. Examples of client electronic devices 926, 928, 930, 932 include personal computer 926, laptop computer 928, smartphone 930, laptop computer 932, a server (not shown), a data-enabled, and a dedicated network device (not shown). Client electronic devices 926, 928, 930, 932 each execute an operating system.

Users 934, 936, 938, 940 may access storage system 900 directly through network 902 or through secondary network 906. Further, storage system 900 may be connected to network 902 through secondary network 906, as illustrated with link line 942.

The various client electronic devices may be directly or indirectly coupled to network 902 (or network 906). For example, personal computer 926 is shown directly coupled to network 902 via a hardwired network connection. Further, laptop computer 932 is shown directly coupled to network 906 via a hardwired network connection. Laptop computer 928 is shown wirelessly coupled to network 902 via wireless communication channel 944 established between laptop computer 928 and wireless access point (e.g., WAP) 946, which is shown directly coupled to network 902. WAP 946 may be, for example, an IEEE 802.11a, 802.11b, 802.11g, 802.11n, Wi-Fi®, and/or Bluetooth® device that is capable of establishing a wireless communication channel 944 between laptop computer 928 and WAP 946. Smartphone 930 is shown wirelessly coupled to network 902 via wireless communication channel 948 established between smartphone 930 and cellular network/bridge 950, which is shown directly coupled to network 902.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
processing a partition size exception associated with a write request for writing a portion of data to a distributed database storage container associated with a partition key within a distributed database system;
processing a partition table entry for the partition key from a partition table;
generating a new linked partition key based upon, at least in part, a previous linked partition key from the partition table entry for the partition key;
generating a distributed database storage container associated with the new linked partition key; and
writing the portion of data to the distributed database storage container associated with the new linked partition key.

2. The computer-implemented method of claim 1, further comprising:
processing a read operation associated with the partition key.

3. The computer-implemented method of claim 2, wherein processing the read operation includes processing the partition key and any linked partition keys from the partition table entry for the partition key.

4. The computer-implemented method of claim 1, wherein each storage container has a fixed storage capacity.

5. The computer-implemented method of claim 1, further comprising:
maintaining a cached partition table by caching at least a portion of the partition table on an instance of the distributed database system.

6. The computer-implemented method of claim 5, further comprising:
in response to generating a new linked partition key, sending a cache update notification to another instance of the distributed database system to invalidate their respective cached partition table.

7. The computer-implemented method of claim 1, further comprising:
generating a temporary hidden placeholder associated with the write request to the distributed database storage container associated with the partition key.

8. A computing system comprising:
a memory; and
a processor configured to process a partition size exception associated with a write request for writing a portion of data to a distributed database storage container associated with a partition key within a distributed database system, to process a partition table entry for the partition key from a partition table, to generate a new linked partition key based upon, at least in part, a previous linked partition key from the partition table entry for the partition key, to generate a distributed database storage container associated with the new linked partition key, to write the portion of data to the distributed database storage container associated with the new linked partition key, and to maintain a cached partition table by caching at least a portion of the partition table on an instance of the distributed database system.

9. The computing system of claim 8, wherein the processor is further configured to:
processing a read operation associated with the partition key.

10. The computing system of claim 9, wherein processing the read operation includes processing the partition key and any linked partition keys from the partition table entry for the partition key.

11. The computing system of claim 8, wherein each storage container has a fixed storage capacity.

12. The computing system of claim 8, wherein the processor is further configured to:
in response to generating a new linked partition key, sending a cache update notification to another instance of the distributed database system to invalidate their respective cached partition table.

13. The computing system of claim 8, wherein processing the partition size exception includes generating a temporary hidden placeholder associated with the write request to the distributed database storage container associated with the partition key.

14. The computing system of claim 8, wherein the distributed database system includes a cached partition table for each regional instance of the distributed database system.

15. A computer program product residing on a non-transitory computer readable medium having a plurality of instructions stored thereon which, when executed by a processor, cause the processor to perform operations comprising:
processing a partition size exception associated with a write request for writing a portion of data to a distributed database storage container associated with a partition key within a distributed database system, wherein processing the partition size exception includes generating a temporary hidden placeholder associated with the write request to the distributed database storage container associated with the partition key;
processing a partition table entry for the partition key from a partition table;
generating a new linked partition key based upon, at least in part, a previous linked partition key from the partition table entry for the partition key;
generating a distributed database storage container associated with the new linked partition key; and
writing the portion of data to the distributed database storage container associated with the new linked partition key.

16. The computer program product of claim 15, wherein the operations further comprise:
processing a read operation associated with the partition key.

17. The computer program product of claim 16, wherein processing the read operation includes processing the partition key and any linked partition keys from the partition table entry for the partition key.

18. The computer program product of claim 15, wherein each storage container has a fixed storage capacity.

19. The computer program product of claim 15, wherein the operations further comprise:
maintaining a cached partition table by caching at least a portion of the partition table on an instance of the distributed database system.

20. The computer program product of claim 19, wherein the operations further comprise:
in response to generating a new linked partition key, sending a cache update notification to another instance of the distributed database system to invalidate their respective cached partition table.
